(19) United States
(12) Patent Application Publication
(10) Pub. No.: US 2013/0135432 A1
(43) Pub. Date: May 30, 2013

(54) DEVICE FOR OUTPUTTING CHROMINANCE SIGNAL AND METHOD THEREOF

(71) Applicants: Albert Hua Tai, Hsinchu City (TW); Feng Chi Wei, Hsinchu City (TW); Heng Yi Liu, Hsinchu City (TW)

(72) Inventors: Albert Hua Tai, Hsinchu City (TW); Feng Chi Wei, Hsinchu City (TW); Heng Yi Liu, Hsinchu City (TW)

(73) Assignee: Silicon Integrated Systems Corp., Hsinchu City (TW)

(21) Appl. No.: 13/307,891

(22) Filed: Nov. 30, 2011

(51) Int. Cl. H04N 13/00

(52) U.S. Cl. 348/43; 348/E13.06

(57) ABSTRACT

A device for outputting a chrominance signal and a method thereof are disclosed. The device includes a motion detection unit, a frame edge detection unit, and an output unit. The motion detection unit judges a motion degree of a frame. The frame edge detection unit judges whether a non-3D luminance signal is extracted from an edge of the frame. The output unit outputs one of a 3D chrominance signal and a non-3D chrominance signal as a resultant chrominance signal according to the motion degree which is judged by the motion detection unit and the judgment result of the frame edge detection unit. The present invention is capable of appropriately selecting the 3D chrominance signal and the non-3D chrominance signal when the frame is in the motion condition.

### TECHNICAL FIELD OF THE INVENTION

The present invention relates to a device, more particularly, to a device for outputting a chrominance signal and a method thereof.

### BACKGROUND OF THE INVENTION

A composite video signal comprises a luminance signal (Y) and a chrominance signal (C). A comb filter is commonly used to separate the luminance signal and the chrominance signal from the composite video signal. The process of separating the luminance signal and the chrominance signal is referred to as a Y/C separation.

There are three types of comb filters used to separate the composite video signal. The three types of comb filters are classified into a one-dimensional (1D) comb filter, a two-dimensional (2D) comb filter and a three-dimensional (3D) comb filter. The 1D comb filter and the 2D comb filter are referred to as a type of non-3D comb filter. In general, the non-3D comb filter is used to separate the luminance signal and the chrominance signal when a frame is under a motion condition, and the 3D comb filter is used to separate the luminance signal and the chrominance signal when the frame is under a static condition.

When the chrominance signal is affected by the luminance signal, a rainbow-like color occurs on the frame. To prevent the rainbow-like color from occurring, a conventional method is executed by selecting a non-3D chrominance signal outputted by the non-3D comb filter when the frame is in the motion condition, or selecting a 3D chrominance signal outputted by the 3D comb filter when the frame is in the static condition. However, sometimes selecting the non-3D chrominance signal is worse than selecting the 3D chrominance signal when the frame is in the motion condition. More particularly, the rainbow-like color occurs more easily by selecting the non-3D chrominance signal when the frame is in the motion condition.

Therefore, there is a need for a solution to appropriately select the 3D chrominance signal and the non-3D chrominance signal when the frame is in the motion condition.

### SUMMARY OF THE INVENTION

An objective of the present invention is to provide a device for outputting a chrominance signal and a method thereof.

In accordance with an aspect of the present invention, a device for outputting a chrominance signal in an image processing system comprises a motion detection unit, a frame edge detection unit, and an output unit. In the system, a composite video signal of a frame has a chrominance component and a luminance component. A 3D comb filter receives the composite video signal of the frame and outputs a 3D chrominance signal based on the chrominance component, and a non-3D comb filter receives the composite video signal of the frame and outputs a non-3D chrominance signal based on the chrominance component and a non-3D luminance signal based on the luminance component. The motion detection unit judges a motion degree of the frame. The frame edge detection unit judges whether the non-3D luminance signal is extracted from an edge of the frame. The output unit receives the 3D chrominance signal and the non-3D chrominance signal and outputs one of the 3D chrominance signal and the non-3D chrominance signal as a resultant chrominance signal according to the motion degree which is judged by the motion detection unit and the judgment result of the frame edge detection unit.

In accordance with another aspect of the present invention, a method for outputting a chrominance signal in an image processing system comprises the following steps. In the system, a composite video signal of a frame has a chrominance component and a luminance component. A 3D comb filter receives the composite video signal of the frame and outputs a 3D chrominance signal based on the chrominance component, and a non-3D comb filter receives the composite video signal of the frame and outputs a non-3D chrominance signal based on the chrominance component and a non-3D luminance signal based on the luminance component. A motion degree of the frame is judged. It is determined whether the non-3D luminance signal is extracted from an edge of the frame. One of the 3D chrominance signal and the non-3D chrominance signal is outputted as a resultant chrominance signal according to the judged motion degree of the frame and the determination result of the non-3D luminance signal.

### BRIEF DESCRIPTION OF THE DRAWINGS

The present invention will be described in detail in conjunction with the appending drawings, in which:

FIG. 1 is a schematic diagram showing an image processing system has a device for outputting a chrominance signal according to an embodiment of the present invention;

FIG. 2 is a schematic diagram showing the chrominance detection unit in FIG. 1; and

FIG. 3 is a flow chart showing a method for outputting a chrominance signal according to the present invention.

### DETAILED DESCRIPTION OF THE INVENTION

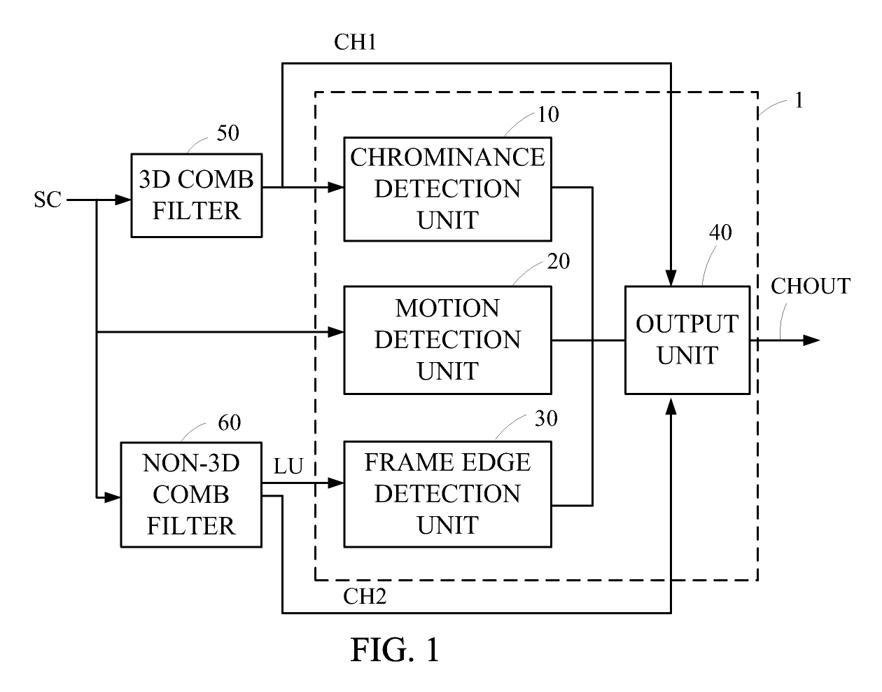

FIG. 1 is a schematic diagram showing an image processing system has a device 1 for outputting a chrominance signal according to an embodiment of the present invention. The image processing system comprises a 3D comb filter 50, a non-3D comb filter 60, and the device 1. A composite video signal SC of a frame has a chrominance component and a luminance component. The 3D comb filter 50 receives the composite video SC of the frame, separates the composite video SC into a 3D chrominance signal CH1 and a 3D luminance signal (not shown), and outputs the 3D chrominance signal CH1 based on the chrominance component. The non-3D comb filter 60 receives the composite video SC of the frame, separates the composite video SC into a non-3D chrominance signal CH2 and a non-3D luminance signal LU, and outputs the non-3D chrominance signal CH2 based on the chrominance component and the non-3D luminance signal based on the luminance component. In the prior arts, a method to avoid the occurrence of the rainbow-like color is executed by selecting the non-3D chrominance CH2 outputted by the non-3D comb filter 60 as a resultant chrominance signal CHOUT when a frame is in the motion condition, or selecting the 3D chrominance signal CH1 outputted by the 3D comb filter 50 as the resultant chrominance signal CHOUT when the frame is in the static condition. However, sometimes selecting the non-3D chrominance signal CH2 is worse than selecting the 3D chrominance signal CH1 although the frame is in the motion condition. The device 1 of the present invention is capable of appropriately selecting one of the 3D chrominance signal CH1 and the non-3D chrominance signal CH2 as the resultant chrominance signal CHOUT according a selecting mechanism. The selecting mechanism will be described later.

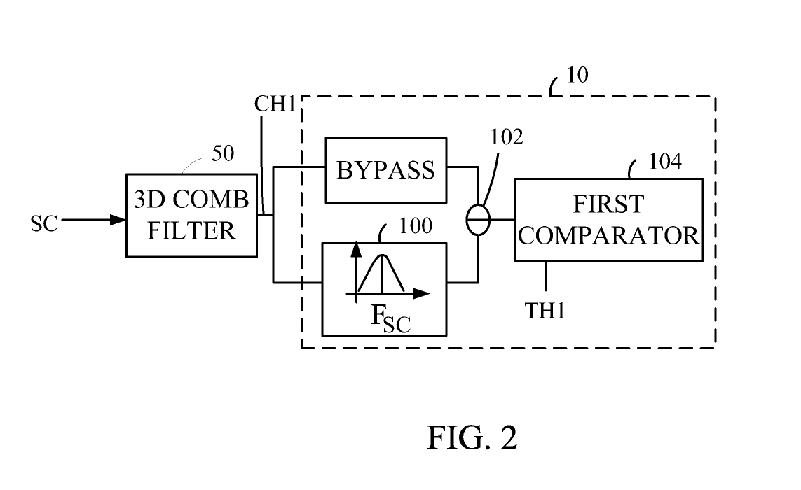

The device 1 of the present invention comprises a chrominance detection unit 10, a motion detection unit 20, a frame edge detection unit 30, and an output unit 40. The chrominance component of the composite video signal SC is modulated onto a carrier frequency (F_{SC} in FIG. 2). The chrominance detection unit 10 receives the 3D chrominance signal CH1 and judges whether a difference value between an amplitude of the 3D chrominance signal CH1 and an amplitude of the 3D chrominance signal CH1 within a frequency range with respect to the carrier frequency (F_{SC} in FIG. 2) of the chrominance component is lower than a first threshold value (TH1 in FIG. 2). The frequency range with respect to the carrier frequency (F_{SC} in FIG. 2) of the chrominance component of the composite video signal SC is adjustable as required. The motion detection unit 20 receives the composite video signal SC and judges a motion degree of the frame. The frame edge detection unit 30 receives the non-3D luminance signal LU and judges whether the non-3D luminance signal LU is extracted from an edge of the frame. The output unit 40 receives the 3D chrominance signal CH1 and the non-3D chrominance signal CH2 and outputs one of the 3D chrominance signal CH1 and the non-3D chrominance signal CH2 as the resultant chrominance signal CHOUT according to the judgment result of the chrominance detection unit 10, the motion degree judged by the motion detection unit 20, and the judgment result of the frame edge detection unit 30.

FIG. 2 is a schematic diagram showing the chrominance detection unit 10 in FIG. 1. The chrominance detection unit 10 comprises a band pass filter 100, a first subtractor 102, and a first comparator 104. The 3D chrominance signal CH1, which is outputted by the 3D comb filter 50, is bypassed (i.e. without being processed) to the first subtractor 102 and inputted to the band pass filter 100. The band pass filter 100 passes a component of the 3D chrominance signal CH1 within the frequency range with respect to the carrier frequency Fsc of the chrominance component of the composite video signal SC while filtering out the other components of the 3D chrominance signal CH1. Then, the first subtractor 102 subtracts the component of the 3D chrominance signal CH1 within the frequency range with respect to the carrier frequency F_{SC} from the 3D chrominance signal CH1 to obtain the difference value between the amplitude of the 3D chrominance signal CH1 and the amplitude of the 3D chrominance signal within the frequency range with respect to the carrier frequency F_{SC} of the chrominance component. Finally, the first comparator 104 compares the subtraction result of the first subtractor 102 (i.e. the difference value between the amplitude of the 3D chrominance signal CH1 and the amplitude of the 3D chrominance signal within the frequency range with respect to the carrier frequency F_{SC} of the chrominance component) with the first threshold value. When the subtraction result of the first subtractor 102 is lower than the first threshold value TH1, it means that the frequency of the 3D chrominance signal CH1 is near the carrier frequency F_{SC} of the chrominance component. When the subtraction result of the first subtractor 102 is greater than the first threshold value TH1, it means that the frequency of the 3D chrominance signal CH1 is not near the carrier frequency Fsc of the chrominance component.

Referring to FIGS. 1-2, one example of the selection mechanism will be described in the following. As mentioned above, the motion detection unit 20 is capable of judging a motion degree of the frame. For example, the motion degree is one selected from a group consisting of a highly motional degree, a commonly motional degree, and a static degree. The different motion degrees can be defined or classified as required, and this is known for one skilled in the same arts of the present invention and omitted herein. When the motion degree indicates that the frame is static, the output unit 40 outputs the 3D chrominance signal CH1. This is because when the frame is static, selecting the 3D chrominance signal CH1 as the output chrominance signal CHOUT must be better than selecting the non-3D chrominance signal CH2 as the resultant chrominance signal CHOUT.

When the motion degree indicates that the frame is commonly motional, the output unit 40 determines which one of the 3D chrominance signal CH1 and the non-3D chrominance signal CH2 is to be outputted as the resultant chrominance signal CHOUT by comparing an amplitude of the 3D chrominance signal CH1 and an amplitude of the non-3D chrominance signal CH2 if the non-3D luminance signal LU is extracted from the edge of the frame. More particularly, when the amplitude of the 3D chrominance signal CH1 is lower than the amplitude of the non-3D chrominance signal CH2, the output unit 40 outputs the 3D chrominance signal CH1. When the amplitude of the non-3D chrominance signal CH2 is lower than the amplitude of the 3D chrominance signal CH1, the output unit 40 outputs the non-3D chrominance signal CH2. By outputting one having a lower amplitude, the intensity of the rainbow-like color can be decreased and thus the image quality is improved.

When the motion degree indicates that the frame is highly motional, the output unit 40 determines which one of the 3D chrominance signal CH1 and the non-3D chrominance signal CH2 is to be outputted as the resultant chrominance signal CHOUT by comparing the amplitude of the 3D chrominance signal CH1 and the amplitude of the non-3D chrominance signal CH2 if the difference value between the amplitude of the 3D chrominance signal CH1 and the amplitude of the 3D chrominance signal CH1 within the frequency range with respect to the carrier frequency F_{SC} of the chrominance component is lower than the first threshold value TH1 and the non-3D luminance signal LU is extracted from the edge of the frame. More particularly, when the amplitude of the 3D chrominance signal CH1 is lower than the amplitude of the non-3D chrominance signal CH2, the output unit 40 outputs the 3D chrominance signal CH1. When the amplitude of the non-3D chrominance signal CH2 is lower than the amplitude of the 3D chrominance signal CH1, the output unit 40 outputs the non-3D chrominance signal CH2.

When the motion degree indicates that the frame is highly motional, the output unit 40 outputs the non-3D chrominance signal CH2 as the resultant chrominance signal CHOUT if the difference value between the amplitude of the 3D chrominance signal CH1 and the amplitude of the 3D chrominance signal CH1 within the frequency range with respect to the carrier frequency F_{SC} of the chrominance component is greater than the first threshold value TH1.

In summary, the selecting mechanism in the above-mentioned example includes four cases. In the first case, when the motion degree indicates that the frame is static, the output unit 40 directly outputs the 3D chrominance signal CH1 as the resultant chrominance signal CHOUT without considering the judgment result of the chrominance detection unit 10 and the judgment result of the frame edge detection unit 30. In the second case, when the motion degree indicates that the frame is commonly motional, the judgment result of the frame edge detection unit 30 is considered but the judgment result of the chrominance detection unit 10 is not considered. In the third case, when the motion indicates that the frame is highly motional, both the judgment result of the chrominance detection unit 10 and the judgment result of the frame edge detection unit 30 are considered. That is, when the motion degree indicates that the frame is highly motional, the output unit 40 determines which one of the 3D chrominance signal CH1 and the non-3D chrominance signal CH2 is to be outputted as the resultant chrominance signal CHOUT by comparing the amplitude of the 3D chrominance signal CH1 and the amplitude of the non-3D chrominance signal CH2 if the difference value between the amplitude of the 3D chrominance signal CH1 and the amplitude of the 3D chrominance signal CH1 within the frequency range with respect to the carrier frequency F_{SC} of the chrominance component is lower than the first threshold value TH1 and the non-3D luminance signal LU is extracted from the edge of the frame. In the fourth case, when the motion degree indicates that the frame is highly motional, the judgment result of the chrominance detection unit 10 is considered but the judgment result of the frame edge detection unit 30 is not considered. That is, when the motion degree indicates that the frame is highly motional, the output unit 40 directly outputs the non-3D chrominance signal CH2 as the resultant chrominance signal CHOUT if the difference value between the amplitude of the 3D chrominance signal CH1 and the amplitude of the 3D chrominance signal CH1 within the frequency range with respect to the carrier frequency F_{SC} of the chrominance component is greater than the first threshold value TH1.

It is noted that the chrominance detection unit 10 is optional to enhance the performance of the device 1 of the present invention. When the device 1 of the present invention comprises only the motion detection 20, the frame edge detection unit 30 (i.e. the device 1 excludes the chrominance detection unit 10), and the output unit 40, the selecting mechanism includes two cases. In the first case, when the motion detection unit 20 judges that the frame is static, the output unit 40 outputs the 3D chrominance signal CH1 as the resultant chrominance signal CHOUT. In the second case, when the motion detection unit 20 judges that the frame is motional, the output unit 40 determines which one of the 3D chrominance signal CH1 and the non-3D chrominance signal CH2 is to be outputted as the resultant chrominance signal CHOUT by comparing the amplitude of the 3D chrominance signal CH1 and the amplitude of the non-3D chrominance signal CH2 if the non-3D luminance signal LU is extracted from the edge of the frame. Furthermore, the motion detection unit 20 and the frame edge detection unit 30 are conventional for one skilled in the same arts of the present invention and thus omitted herein.

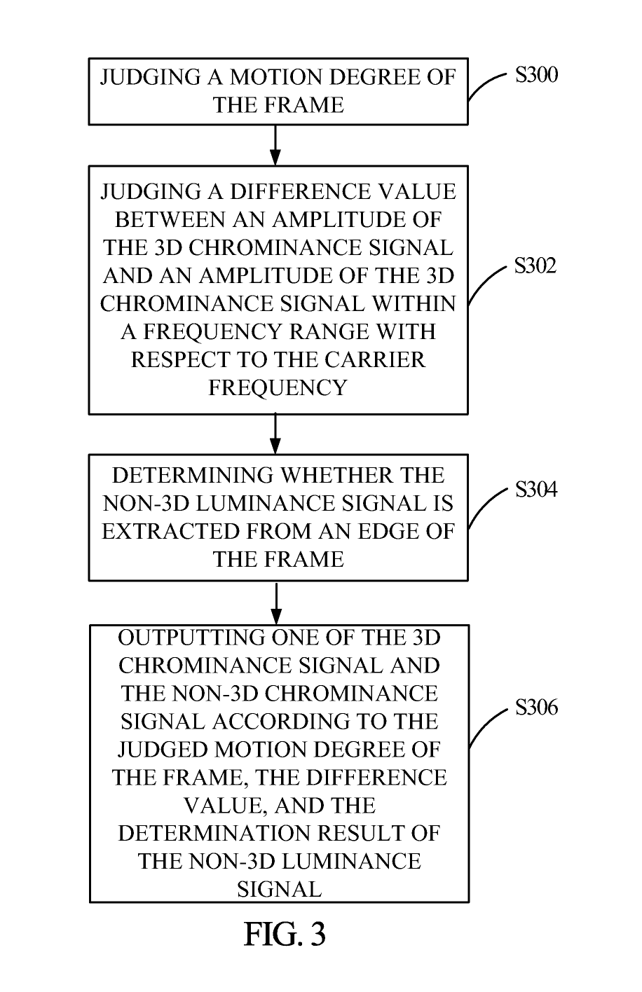

Referring to FIG. 3, which is a flow chart showing a method for outputting a chrominance signal in an image processing system according to the present invention. In the image processing system, a composite video signal has a chrominance component and a luminance component. The chrominance component is modulated onto a carrier frequency. A 3D comb filter receives the composite video signal of the frame and outputs a 3D chrominance signal based on the chrominance component, and a non-3D comb filter receives the composite video signal of the frame and outputs a non-3D chrominance signal based on the chrominance component and a non-3D luminance signal based on the luminance component. The method includes the following steps. In step S300, a motion degree of the frame is judged.

In step S302, it is judged whether a difference value between an amplitude of the 3D chrominance signal and an amplitude of the 3D chrominance signal within a frequency range with respect to the carrier frequency of the chrominance component is lower than a first threshold value. The frequency range with respect to the carrier frequency of the 3D chrominance signal is adjustable as required. Step S302 comprises: passing a component of the 3D chrominance signal within the frequency range with respect to the carrier frequency of the chrominance component; subtracting the component of the 3D chrominance signal within the frequency range with respect to the carrier frequency of the chrominance component from the 3D chrominance signal to obtain the difference value between the amplitude of the 3D chrominance signal and the amplitude of the 3D chrominance signal within the frequency range with respect to the carrier frequency of the chrominance component; and comparing the difference value with the first threshold value.

In step S304, it is determined whether the non-3D luminance signal is extracted from an edge of the frame.

In step S306, one of the 3D chrominance signal and the non-3D chrominance signal is outputted as a resultant chrominance signal according to the judged motion degree of the frame, the difference value between the amplitude of the 3D chrominance signal and the amplitude of the 3D chrominance signal within the frequency range with respect to the carrier frequency of the chrominance component, and the determination result of the non-3D luminance signal.

When the motion degree indicates that the frame is static, the 3D chrominance signal is outputted as the resultant chrominance signal. When the motion degree indicates that the frame is commonly motional, which one of the 3D chrominance signal and the non-3D chrominance signal is determined to be outputted as the resultant chrominance signal by comparing the amplitude of the 3D chrominance signal and the amplitude of the non-3D chrominance signal if the non-3D luminance signal is extracted from the edge of the frame. More particularly, one of the 3D chrominance signal and the non-3D chrominance signal whose amplitude is lower is outputted as the resultant chrominance signal. When the motion degree indicates that the frame is highly motional, which one of the 3D chrominance signal and the non-3D chrominance signal is determined to be outputted as the resultant chrominance signal by comparing the amplitude of the 3D chrominance signal and the amplitude of the non-3D chrominance signal if the difference value between the amplitude of the 3D chrominance signal and the amplitude of the 3D chrominance signal within the frequency range with respect to the carrier frequency of the chrominance component is lower than the first threshold value and the non-3D luminance signal is extracted from the edge of the frame. More particularly, one of the 3D chrominance signal and the non-3D chrominance signal whose amplitude is lower is outputted. When the motion degree indicates that the frame is highly motional, the non-3D chrominance signal is outputted as the resultant chrominance signal if the difference value between the amplitude of the 3D chrominance signal and the amplitude of the 3D chrominance signal within the frequency range with respect to the carrier frequency of the chrominance component is greater than the first threshold value.

It is noted that step S302 is optional. When the method excludes the step S302, there are two cases for determining the resultant chrominance signal. In the first case, when the motion degree indicates that the frame is static, the 3D chrominance signal is outputted as the resultant chrominance signal. In the second case, when the motion degree indicates that the frame is motional, which one of the 3D chrominance signal and the non-3D chrominance signal is determined to be outputted as the resultant chrominance signal by comparing the amplitude of the 3D chrominance signal and the amplitude of the non-3D chrominance signal if the non-3D luminance signal is extracted from the edge of the frame. More particularly, one of the 3D chrominance signal and the non-3D chrominance signal whose amplitude is lower is outputted as the resultant chrominance signal.

The device 1 for outputting the chrominance signal and the method thereof are capable of appropriately selecting the 3D chrominance signal and the non-3D chrominance signal as the resultant chrominance signal when the frame is in the motion condition. As a result, the occurrence of the rainbow-like color can be avoided by appropriately selecting the 3D chrominance signal and the non-3D chrominance signal as the resultant chrominance signal.

While the preferred embodiments of the present invention have been illustrated and described in detail, various modifications and alterations can be made by persons skilled in this art. The embodiment of the present invention is therefore described in an illustrative but not restrictive sense. It is intended that the present invention should not be limited to the particular forms as illustrated, and that all modifications and alterations which maintain the spirit and realm of the present invention are within the scope as defined in the appended claims.

What is claimed is:

1. A device for outputting a chrominance signal in an image processing system, in the system, a composite video signal of a frame having a chrominance component and a luminance component, a 3D comb filter receiving the composite video signal of the frame and outputting a 3D chrominance signal based on the chrominance component, a non-3D comb filter receiving the composite video signal of the frame and outputting a non-3D chrominance signal based on the chrominance component and a non-3D luminance signal based on the luminance component, the device comprising:
a motion detection unit, judging a motion degree of the frame;
a frame edge detection unit, judging whether the non-3D luminance signal is extracted from an edge of the frame; and
an output unit, receiving the 3D chrominance signal and the non-3D chrominance signal and outputting one of the 3D chrominance signal and the non-3D chrominance signal as a resultant chrominance signal according to the motion degree which is judged by the motion detection unit and the judgment result of the frame edge detection unit.

2. The device of claim 1, wherein when the motion degree indicates that the frame is static, the output unit outputs the 3D chrominance signal as the resultant chrominance signal; and
when the motion degree indicates that the frame is motional, the output unit determines which one of the 3D chrominance signal and the non-3D chrominance signal is to be outputted as the resultant chrominance signal by comparing an amplitude of the 3D chrominance signal and an amplitude of the non-3D chrominance signal if the non-3D luminance signal is extracted from the edge of the frame.

3. The device of claim 2, wherein when the motion degree indicates that the frame is motional, the output unit outputs one of the 3D chrominance signal and the non-3D chrominance signal whose amplitude is lower.

4. The device of claim 1, wherein the chrominance component is modulated onto a carrier frequency, and the device further comprises a chrominance detection unit for judging whether a difference value between an amplitude of the 3D chrominance signal and an amplitude of the 3D chrominance signal within a frequency range with respect to the carrier frequency of the chrominance component is lower than a first threshold value.

5. The device of claim 4, wherein the chrominance detection unit comprises:
a band pass filter, passing a component of the 3D chrominance signal within the frequency range with respect to the carrier frequency of the chrominance component;
a first subtractor, performing a subtraction of the output of the band pass filter and the 3D chrominance signal; and
a first comparator, comparing the subtraction result of the first subtractor with the first threshold value.

6. The device of claim 4, wherein when the motion degree indicates that the frame is static, the output unit outputs the 3D chrominance signal as the resultant chrominance signal;
when the motion degree indicates that the frame is commonly motional, the output unit determines which one of the 3D chrominance signal and the non-3D chrominance signal is to be outputted as the resultant chrominance signal by comparing an amplitude of the 3D chrominance signal and an amplitude of the non-3D chrominance signal if the non-3D luminance signal is extracted from the edge of the frame;
when the motion degree indicates that the frame is highly motional, the output unit determines which one of the 3D chrominance signal and the non-3D chrominance signal is to be outputted as the resultant chrominance signal by comparing the amplitude of the 3D chrominance signal and the amplitude of the non-3D chrominance signal if the difference value between the amplitude of the 3D chrominance signal and the amplitude of the 3D chrominance signal within the frequency range with respect to the carrier frequency of the chrominance component is lower than the first threshold value and the non-3D luminance signal is extracted from the edge of the frame; and
when the motion degree indicates that the frame is highly motional, the output unit determines that the non-3D chrominance signal is to be outputted as the resultant chrominance signal if the difference value between the amplitude of the 3D chrominance signal and the amplitude of the 3D chrominance signal within the frequency range with respect to the carrier frequency of the chrominance component is greater than the first threshold value.

7. The device of claim 6, wherein when the motion degree indicates that the frame is commonly motional, the output unit outputs one of the 3D chrominance signal and the non-3D chrominance signal whose amplitude is lower if the non-3D luminance signal is extracted from the edge of the frame.

8. The device of claim 6, wherein when the motion degree indicates that the frame is highly motional, the output unit outputs one of the 3D chrominance signal and the non-3D chrominance signal whose amplitude is lower if the difference value between the amplitude of the 3D chrominance signal and the amplitude of the 3D chrominance signal within the frequency range with respect to the carrier frequency of the chrominance component is lower than the first threshold value and the non-3D luminance signal is extracted from the edge of the frame.

9. The device of claim 4, wherein the frequency range with respect to the carrier frequency of the chrominance component is adjustable.

10. A method for outputting a chrominance signal in an image processing system, in the system, a composite video signal of a frame having a chrominance component and a luminance component, a 3D comb filter receiving the composite video signal of the frame and outputting a 3D chrominance signal based on the chrominance component, a non-3D comb filter receiving the composite video signal of the frame and outputting a non-3D chrominance signal based on the chrominance component and a non-3D luminance signal based on the luminance component, the method comprising:
judging a motion degree of the frame;
determining whether the non-3D luminance signal is extracted from an edge of the frame; and
outputting one of the 3D chrominance signal and the non-3D chrominance signal as a resultant chrominance signal according to the judged motion degree of the frame and the determination result of the non-3D luminance signal.

11. The method of claim 10, wherein when the motion degree indicates that the frame is static, the 3D chrominance signal is outputted as the resultant chrominance signal; and
when the motion degree indicates that the frame is motional, which one of the 3D chrominance signal and the non-3D chrominance signal is determined to be outputted by comparing an amplitude of the 3D chrominance signal and an amplitude of the non-3D chrominance signal if the non-3D luminance signal is extracted from the edge of the frame.

12. The method of claim 11, wherein when the motion degree indicates that the frame is motional, one of the 3D chrominance signal and the non-3D chrominance signal whose amplitude is lower is outputted as the resultant chrominance signal.

13. The method of claim 10, wherein the chrominance signal is modulated onto a carrier frequency, and the method further comprise a step of judging whether a difference value between an amplitude of the 3D chrominance signal and an amplitude of the 3D chrominance signal within a frequency range with respect to the carrier frequency of the chrominance component is lower than a first threshold value.

14. The method of claim 13, wherein the step of judging whether the difference value between the amplitude of the 3D chrominance signal and the amplitude of the 3D chrominance signal within the frequency range with respect to the carrier frequency of the chrominance component is lower than the first threshold value comprises:
passing a component of the 3D chrominance signal within the frequency range with respect to the carrier frequency of the chrominance component;
subtracting the component of the 3D chrominance signal within the frequency range with respect to the carrier frequency of the chrominance component from the 3D chrominance signal to obtain the difference value between the amplitude of the 3D chrominance signal and the amplitude of the 3D chrominance signal within the frequency range with respect to the carrier frequency of the chrominance component; and
comparing the difference value with the first threshold value.

15. The method of claim 13, wherein when the motion degree indicates that the frame is static, the 3D chrominance signal is outputted as the resultant chrominance signal;
when the motion degree indicates that the frame is commonly motional, which one of the 3D chrominance signal and the non-3D chrominance signal is determined to be outputted as the resultant chrominance signal by comparing an amplitude of the 3D chrominance signal and an amplitude of the non-3D chrominance signal if the non-3D luminance signal is extracted from the edge of the frame;
when the motion degree indicates that the frame is highly motional, which one of the 3D chrominance signal and the non-3D chrominance signal is determined to be outputted as the resultant chrominance signal by comparing the amplitude of the 3D chrominance signal and the amplitude of the non-3D chrominance signal if the difference value between the amplitude of the 3D chrominance signal and the amplitude of the 3D chrominance signal within the frequency range with respect to the carrier frequency of the chrominance component is lower than the first threshold value and the non-3D luminance signal is extracted from the edge of the frame; and
when the motion degree indicates that the frame is highly motional, the non-3D chrominance signal is to be outputted as the resultant chrominance signal if the difference value between the amplitude of the 3D chrominance signal and the amplitude of the 3D chrominance signal within the frequency range with respect to the carrier frequency of the chrominance component is greater than the first threshold value.

16. The method of claim 15, wherein when the motion degree indicates that the frame is commonly motional, one of the 3D chrominance signal and the non-3D chrominance signal whose amplitude is lower is determined to be outputted if the non-3D luminance signal is extracted from the edge of the frame.

17. The method of claim 15, wherein when the motion degree indicates that the frame is highly motional, one of the 3D chrominance signal and the non-3D chrominance signal whose amplitude is lower is outputted as the resultant chrominance signal if the difference value between the amplitude of the 3D chrominance signal and the amplitude of the 3D chrominance signal within the frequency range with respect to the carrier frequency of the chrominance component is lower than the first threshold value and the non-3D luminance signal is extracted from the edge of the frame.

18. The method of claim 13, wherein the frequency range with respect to the carrier frequency of the 3D chrominance signal is adjustable.
